(19) United States
(12) Patent Application Publication
(10) Pub. No.: US 2025/0184224 A1
(43) Pub. Date: Jun. 5, 2025

(54) VIRTUAL RESOURCE PROCESSING METHOD AND APPARATUS

(71) Applicant: CLOUD INTELLIGENCE ASSETS HOLDING (SINGAPORE) PRIVATE LIMITED, Singapore (SG)

(72) Inventor: Jun PIAO, Hangzhou (CN)

(21) Appl. No.: 18/841,647

(22) PCT Filed: Mar. 10, 2023
(86) PCT No.: PCT/CN2023/080914

§ 371 Date: Aug. 26, 2024

(30) Foreign Application Priority Data
Mar. 17, 2022 (CN) 202210263173.7

(51) Int. Cl. H04L 41/0896

(52) U.S. Cl. CPC H04L 41/0896

(57) ABSTRACT

Embodiments of the present specification provide a virtual resource processing method and apparatus, where the virtual resource processing method includes: acquiring a data processing request received by a network card driver module within a preset time period; determining, according to a data processing type corresponding to the data processing request, a first resource consumption result corresponding to a virtual storage module of a target virtual machine and a second resource consumption result corresponding to a virtual network module of the target virtual machine; and adjusting, according to the first resource consumption result and/or the second resource consumption result, virtual resources of the virtual storage module and the virtual network module.

### CROSS-REFERENCE TO RELATED APPLICATION

This application is a National Stage of International Application No. PCT/CN2023/080914, filed on Mar. 10, 2023, which claims priority to Chinese patent application No. 202210263173.7, filed with the China National Intellectual Property Administration on Mar. 17, 2022 and entitled “VIRTUAL RESOURCE PROCESSING METHOD AND APPARATUS”. These applications are hereby incorporated by reference in their entireties.

### TECHNICAL FIELD

An embodiment of the present specification relates to the field of computer technology and, in particular, to a virtual resource processing method.

### BACKGROUND

At present, most of public cloud vendors in mainstream use hardware offload cards as flow forwarding apparatus for cloud disks and VPC (Virtual Private Cloud) networks. Generally speaking, a cloud vendor may set, for a virtual machine instance, a bandwidth requirement limit for a storage network as well as a bandwidth requirement limit for a VPC network. For example, an upper-limit for a VPC network is 10 Gb and an upper-limit for a storage network is 6 Gb. Based on this, during an actual data processing process, a transmission capacity of the VPC network and a throughput capacity of the cloud disk are respectively limited, resulting in long consuming time both in a data loading process and a data distributing process of a data processing task.

Therefore, an effective method to solve this kind of problems is further provided.

### SUMMARY

In view of this, an embodiment of the present specification provides a virtual resource processing method. One or more embodiments of the present specification further relate to a virtual resource processing apparatus, a computing device, a computer-readable storage medium and a computer program, so as to solve technical defects in the prior art.

According to a first aspect of embodiments of the present specification, a virtual resource processing method is provided, including:
acquiring a data processing request received by a network card driver module within a preset time period;
determining, according to a data processing type corresponding to the data processing request, a first resource consumption result corresponding to a virtual storage module of a target virtual machine and a second resource consumption result corresponding to a virtual network module of the target virtual machine;
adjusting, according to the first resource consumption result and/or the second resource consumption result, virtual resources of the virtual storage module and the virtual network module.

In an implementation, the virtual resource processing method further includes:
receiving a data read/write request of a first driver module via the virtual storage module;
parsing the data read/write request to generate a corresponding parsing result, and sending the parsing result to the network card driver module.

In an implementation, the virtual resource processing method further includes:
receiving a data read/write request of a second driver module via the virtual network module; and
parsing the data read/write request to generate a corresponding parsing result, and sending the parsing result to the network card driver module.

In an implementation, the virtual resource processing method further includes:
forwarding the parsing result to a physical network card of a host machine via the network card driver module;
encapsulating the parsing result according to a preset network transmission protocol and sending an encapsulation result to a storage server via the physical network card, where the encapsulation result is parsed by the storage server which returns to-be-read data of the target virtual machine according to the parsing result.

In an implementation, the virtual resource processing method further includes:
forwarding to-be-distributed data to a physical network card of a host machine via the network card driver module;
encapsulating the to-be-distributed data according to a preset network transmission protocol and sending an encapsulation result to at least one virtual machine in a virtual private cloud network via the physical network card, where the virtual private cloud network includes the target virtual machine and the at least one virtual machine.

In an implementation, the virtual resource processing method further includes:
determining a first to-be-consumed virtual resource of the virtual storage module based on an adjustment result;
sending to-be-distributed data in a virtual machine memory to the storage server by using the first to-be-consumed virtual resource.

In an implementation, the virtual resource processing method further includes:
training a to-be-trained speech recognition model by taking the to-be-read data as training data, to generate a trained speech recognition model.

In an implementation, parsing the data read/write request to generate the corresponding parsing result, and sending the parsing result to the network card driver module include: parsing the data read/write request by using the second to-be-consumed virtual resource to generate the corresponding parsing result, and sending the parsing result to the network card driver module; and the virtual resource processing method further includes:
determining a second to-be-consumed virtual resource of the virtual network module based on an adjustment result;
forwarding to-be-distributed data in a virtual machine memory to a physical network card of a host machine via the network card driver module;
encapsulating the to-be-distributed data according to a preset network transmission protocol and sending an encapsulation result to at least one virtual machine in a virtual private cloud network via the physical network card, where the virtual private cloud network includes the target virtual machine and the at least one virtual machine.

In an implementation, determining, according to the data processing type corresponding to the data processing request, the first resource consumption result corresponding to the virtual storage module of the target virtual machine and the second resource consumption result corresponding to the virtual network module of the target virtual machine includes:
performing, according to the data processing type corresponding to the data processing request via a flow sensing sub-module in a flow adapting module, statistics on access flows in the virtual storage module and the virtual network module of the target virtual machine within the preset time period;
determining, according to a statistical result of the access flows, the first resource consumption result corresponding to the virtual storage module and the second resource consumption result of the virtual network module.

In an implementation, adjusting, according to the first resource consumption result and/or the second resource consumption result, the virtual resources of the virtual storage module and the virtual network module includes:
adjusting an initial ratio of the virtual resources of the virtual storage module and the virtual network module via a flow controlling sub-module in the flow adapting module, according to the first resource consumption result and/or the second resource consumption result.

In an implementation, adjusting, according to the first resource consumption result and/or the second resource consumption result, the virtual resources of the virtual storage module and the virtual network module includes:
in a case that the first resource consumption result is greater than a first preset threshold, adjusting an initial ratio of the virtual resources of the virtual storage module and the virtual network module; and/or
in a case that the second resource consumption result is greater than a second preset threshold, adjusting an initial ratio of the virtual resources of the virtual storage module and the virtual network module.

According to a second aspect of embodiments of the present specification, a virtual resource processing apparatus is provided, including:
an acquiring module, configured to acquire a data processing request received by a network card driver module within a preset time period;
a determining module, configured to determine, according to a data processing type corresponding to the data processing request, a first resource consumption result corresponding to a virtual storage module of a target virtual machine and a second resource consumption result corresponding to a virtual network module of the target virtual machine; and
an adjusting module, configured to adjust, according to the first resource consumption result and/or the second resource consumption result, virtual resources of the virtual storage module and the virtual network module.

According to a third aspect of embodiments of the present specification, a computing device is provided, including:
a memory and a processor;
the memory is configured to store computer-executable instructions, and the processor is configured to execute the computer-executable instructions to implement the steps of the virtual resource processing method according to any item of the first aspect.

According to a fourth aspect of embodiments of the present specification, a computer-readable storage medium is provided, the computer-readable storage medium stores computer-executable instructions thereon, when the computer-readable storage medium is executed by a processor, the steps of the virtual resource processing method according to any item of the first aspect are implemented.

According to a fifth aspect of embodiments of the present specification, a computer program is provided, when the computer program is executed in a computer, the computer is caused to perform the steps of the virtual resource processing method according to any item of the first aspect.

In an embodiment of the present specification, a data processing request received by a network card driver module within a preset time period is acquired; a first resource consumption result corresponding to a virtual storage module of a target virtual machine and a second resource consumption result corresponding to a virtual network module of the target virtual machine are determined according to a data processing type corresponding to the data processing request; and virtual resources of the virtual storage module and the virtual network module are adjusted according to the first resource consumption result and/or the second resource consumption result.

In the embodiment of the present specification, resource consumption results of the virtual storage module and the virtual network module are respectively determined according to loads of the virtual storage module and/or the virtual network module, thus a proportion of the virtual resources of the virtual storage module and the virtual network module is dynamically adjusted according to the resource consumption results. In this way, it is beneficial for improving utilization rates of virtual resources of the virtual storage module and the virtual network module, and beneficial for reducing time consumed by data processing, thus improving the efficiency of data processing.

### BRIEF DESCRIPTION OF DRAWINGS

FIG. 1 is a flowchart of a virtual resource processing method provided in an embodiment of the present specification.

FIG. 2 is a schematic diagram of a virtual resource processing process provided in an embodiment of the present specification.

FIG. 3 is a flowchart of a processing process of a virtual resource processing method provided in an embodiment of the present specification.

FIG. 4 is a schematic structural diagram of a virtual resource processing apparatus provided in an embodiment of the present specification.

FIG. 5 is a structural block diagram of a computing device provided in an embodiment of the present specification.

### DESCRIPTION OF EMBODIMENTS

Many specific details are set forth in the following description to facilitate thorough understanding of the present specification. However, the present specification can be implemented in many other ways different from those described herein, and those skilled in the art can make similar generalization without departing from the connotation of the present specification. Therefore, the present specification is not limited by the specific implementations disclosed below.

A term used in one or more embodiments of the present specification is only for the purpose of describing a particular embodiment, rather than intended to limit the one or more embodiments of the present specification. A singular form with “a”, “the” or “said”, used in one or more embodiments of the present specification, and appended claims, is also intended to include plural forms, unless a context clearly indicates otherwise. It should also be understood that the term “and/or” used in one or more embodiments of the present specification refers to and includes any or all possible combinations of one or more associated listed items.

It should be understood that, although terms such as “first” and “second” may be used in one or more embodiments of the present specification to describe various information, the information should not be limited to these terms. These terms are only used to distinguish information of the same type from each other. For example, “first” may also be referred to as “second” without departing from the scope of one or more embodiments of the present specification, and similarly, “second” may also be referred to as “first”. Depending on context, the word “if” as used here may be interpreted as “at a time” or “when” or “in response to determining”.

First of all, terms related to one or more embodiments of the present specification are explained as follows.

PCIe (Peripheral Component Interconnect Express): an important branch of a computer bus, which follows existing PCI programming concepts and signal standards, and builds a higher-speed serial communication system standard.

VPC (Virtual Private Cloud): a virtual private cloud (Private Cloud) that exists in a shared or public cloud, i.e. an internet cloud.

P2P (peer-to-peer): a network technology and a network topology.

In the present specification, a virtual resource processing method is provided. The present specification also relates to a virtual resource processing apparatus, a computing device, a computer-readable storage medium and a computer program, which are described one by one in detail in the following embodiments.

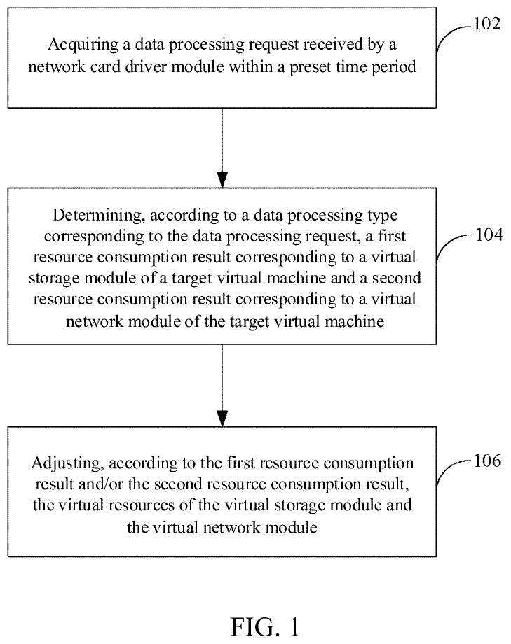

FIG. 1 shows a flowchart of a virtual resource processing method provided according to an embodiment of the present specification, which specifically includes the following steps.

Step 102, acquiring a data processing request received by a network card driver module within a preset time period.

Specifically, the virtual resource processing method provided in an embodiment of the present specification is applied to a host machine, which includes a virtual machine.

Here, the network card driver module (user Network interface card driver) is a network card driver of a physical network card of the host machine, which is deployed in a hardware offload card. The data processing request is a data read/write request, i.e. an I/O request.

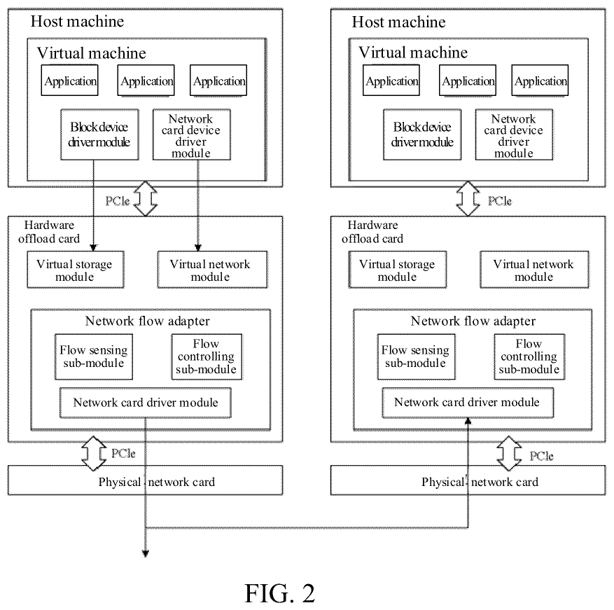

A schematic diagram of a virtual resource processing process provided in an embodiment of the present specification is shown in FIG. 2. In FIG. 2, a hardware offload card includes a virtual storage module and a virtual network module; and a virtual machine includes a block device driver module and a network card device driver module. A data processing request received by the network card driver module is sent by the virtual storage module and the virtual network module. A data processing request of the virtual storage module is sent by an upper-layer application of the virtual machine through the block device driver module (virtio-blk driver), and a data processing request of the virtual network module is sent by the upper-layer application of the virtual machine through the network card device driver module (virtio-net driver).

Therefore, in a case that the data processing request is a data read/write request, it is possible to receive the data read/write request of a first driver module by the virtual storage module;
parse the data read/write request to generate a corresponding parsing result, and send the parsing result to the network card driver module.

Alternatively, it is also possible to receive the data read/write request of a second driver module by the virtual network module;
parse the data read/write request to generate a corresponding parsing result, and send the parsing result to the network card driver module.

Specifically, the virtual storage module is an SPDK (Storage Performance Development Kit), the virtual network module is a DPDK (Data Plane Development Kit), the first driver module is the block device driver module, and the second driver module is the network card device driver module.

The upper-layer application of the virtual machine may forward, by using the block device driver module (virtio-blk driver), the data read/write request to the virtual storage module (SPDK module) of the hardware offload card (offload card) through a PCIe bus. A block device polling driver sub-module (blk pmd, block polling mode driver) in the virtual storage module parses the data read/write request, and then sends a parsing result to the network card driver module, specifically a user-state network card driver module (user network interface card driver).

Alternatively, the upper-layer application of the virtual machine may forward, by using the network card device driver module (virtio-net driver), the data read/write request to the virtual network module (DPDK module) of the hardware offload card (offload card) through a PCIe bus. A network card device polling driver sub-module (net pmd, network polling mode driver) in the virtual network module parses the data read/write request, and then sends a parsing result to the network card driver module (user network interface card driver).

Here, the SPDK, as a back end of a virtual machine block device, processes the data read/write request sent by the virtio-blk driver in a polling manner, and forwards a processing result to the user network interface card driver.

Similarly, the DPDK, as a back end of a virtual machine network device, processes the data read/write request of the virtio-net driver in a polling manner, and forwards a processing result to the user network interface the card driver.

Step 104, determining, according to a data processing type corresponding to the data processing request, a first resource consumption result corresponding to a virtual storage module of a target virtual machine and a second resource consumption result corresponding to a virtual network module of the target virtual machine.

In a specific implementation, determining, according to the data processing type corresponding to the data processing request, the first resource consumption result corresponding to the virtual storage module of the target virtual machine and the second resource consumption result corresponding to the virtual network module of the target virtual machine includes:
a flow sensing sub-module in a flow adapting module performing, according to the data processing type corresponding to the data processing request, statistics on access flows in the virtual storage module and the virtual network module of the target virtual machine within the preset time period;
determining, according to a statistical result of the access flows, the first resource consumption result corresponding to the virtual storage module and the second resource consumption result of the virtual network module.

Specifically, the first resource consumption result and the second resource consumption result may be consumption results of virtual resources, and the virtual resources may be bandwidth. Therefore, a resource consumption result may be an occupancy result of the bandwidth.

In an actual application, the virtual storage module and the virtual network module are configured to process different types of data processing requests. For example, the virtual storage module may be configured to process a data read request, that is, to read data from a remote storage server into a virtual machine memory, and the virtual network module may be configured to process a data write request, that is, to write data from a virtual machine memory into other virtual machine memories, specifically, that is to distribute data to other virtual machine memories.

Since the host machine may allocate a certain amount of virtual resources to the virtual storage module and the virtual network module respectively in advance, both the virtual storage module and the virtual network module use their respective virtual resources allocated in advance to read/write data during a data read/write process. However, the data read/write requests processed by the virtual storage module and the virtual network module correspond to different data processing types, when the virtual storage module uses a virtual resource to read data from the remote storage server into the virtual machine memory, the virtual resource for the virtual network module is in an idle state. After the virtual machine performs data processing based on the read data, the virtual network module may distribute a data processing result to other virtual machines using its virtual resource. In this process, the virtual resource for the virtual storage module is in an idle state. As a result, utilization rates of the virtual resources of the virtual storage module and the virtual network module are low.

Therefore, in the embodiments of the present specification, the flow adapting module is configured, and the flow sensing sub-module in the flow adapting module is used for obtaining the statistics on the access flows in the virtual storage module and the virtual network module within the certain time period in real time, so as to determine virtual resource consumptions per unit time (i.e. bandwidth occupancy rates per unit time) for the virtual storage module and the virtual network module according to the statistical result, and consequently adjust the virtual resources of the two according to the statistical result.

In the schematic diagram of the virtual resource processing process shown in FIG. 2, the hardware offload card contains a network flow adapter (Flow Adapter), and the network flow adapter contains a flow sensing sub-module (Flow Sensor) and a flow controlling sub-module (Flow Controller). The flow sensing sub-module is responsible for obtaining statistics on access flows in the virtual storage module and the virtual network module in real time, analyzing load trends of a storage flow and a network flow based on thresholds of a current storage bandwidth of the virtual storage module and a current network bandwidth of the virtual network module, and then sending an analysis result to the flow controlling sub-module, so that the flow controlling sub-module may dynamically adjust a ratio of the storage flow and the network flow according to the analysis result on the flow load from the flow sensing sub-module.

Step 106, adjusting, according to the first resource consumption result and/or the second resource consumption result, the virtual resources of the virtual storage module and the virtual network module.

In a specific implementation, adjusting, according to the first resource consumption result and/or the second resource consumption result, the virtual resources of the virtual storage module and the virtual network module includes:
in a case that the first resource consumption result is greater than a first preset threshold, adjusting an initial ratio of the virtual resources of the virtual storage module and the virtual network module; and/or
in a case that the second resource consumption result is greater than a second preset threshold, adjusting an initial ratio of the virtual resources of the virtual storage module and the virtual network module.

Specifically, as described above, in a complete data processing process, usually first the virtual storage module reads data from a remote storage server into a virtual machine memory by using a virtual resource, then after the virtual machine performs data processing based on the read data, the virtual network module may distribute a data processing result to other virtual machines by using its virtual resource.

Here, the virtual storage module needs to be used during a data reading process, that is, the virtual resource of the virtual storage module is occupied for data reading. In this process, the virtual resource of the virtual network module is in an idle state. The virtual network module needs to be used during a data distributing process, that is, the virtual resource of the virtual network module needs to be occupied for data distribution. In this process, the virtual resource of the virtual storage module is in an idle state. As a result, utilization rates of virtual resources of the virtual storage module and the virtual network module are low.

In order to improve the utilization rate of the virtual resource and improve the efficiency of data processing, in an embodiment of the present specification, statistics on consumption results of the virtual resources of the virtual network module and the virtual storage module may be obtained in real time, so that a virtual resource ratio of the virtual network module and the virtual storage module is adjusted according to a statistical result, thereby improving the efficiency of resource utilization.

Specifically, after the first resource consumption result of the virtual storage module and/or the second resource consumption result of the virtual network module are obtained, the first resource consumption result may be compared with a first preset threshold, and/or the second resource consumption result may be compared with a second preset threshold, so as to determine an adjustment direction and an adjustment amplitude of the virtual resources of the virtual storage module and the virtual network module according to a comparison result.

Here, when the first resource consumption result is greater than the first preset threshold, the virtual resource ratio for the virtual storage module may be increased, that is, a storage bandwidth may be increased, to improve data reading performance; when the second resource consumption result is greater than the second preset threshold, a network bandwidth may be increased to improve data distributing performance.

Alternatively, adjusting, according to the first resource consumption result and/or the second resource consumption result, the virtual resources of the virtual storage module and the virtual network module includes:

a flow controlling sub-module in the flow adapting module adjusting an initial ratio of the virtual resources of the virtual storage module and the virtual network module according to the first resource consumption result and/or the second resource consumption result.

Specifically, in the schematic diagram of the virtual resource processing process shown in FIG. 2, the hardware offload card contains a network flow adapter (Flow Adapter), and the network flow adapter contains a flow sensing sub-module (Flow Sensor). After analyzing load trends of a storage flow and a network flow, the flow sensing sub-module sends an analysis result to a flow controlling sub-module, so that the flow controlling sub-module dynamically adjusts a ratio of the storage flow and the network flow according to the analysis result on the flow load from the flow sensing sub-module, so as to meet a use requirement on virtual resources in the current data processing process.

In an embodiment of the present specification, a capability of a fusion change configuration on a storage network and a VPC network (virtual private cloud network) of a virtual machine is realized based on hardware offload technology. A storage bandwidth and a network bandwidth of the virtual machine are both taken over by a hardware offload card, and a ratio of the storage bandwidth and the network bandwidth is dynamically adjusted according to a load situation of the virtual machine, thus realizing a flexible mutual conversion of the above two bandwidth resources, providing a better throughput performance for an upper-layer service and significantly improving a resource utilization rate of a physical network.

In a specific implementation, after receiving a parsing result generated from parsing a data processing request by a virtual storage module, a network card driver module may forward the parsing result to a physical network card of a host machine; and
the physical network card encapsulates the parsing result according to a preset network transmission protocol, and sends an encapsulation result to a storage server, where the encapsulation result is parsed by the storage server which returns to-be-read data of the target virtual machine according to the parsing result.

Similarly, after receiving a data distributing request of a virtual network module, a network card driver module may forward to-be-distributed data carried in the data distributing request to a physical network card of a host machine; and
the physical network card encapsulates the to-be-distributed data according to a preset network transmission protocol, and sends an encapsulation result to at least one virtual machine in a virtual private cloud network, where the virtual private cloud network includes the target virtual machine and the at least one virtual machine.

Specifically, the physical network card (Network Card) is a physical network card on the hardware offload card, and is responsible for forwarding the data processing request to the remote storage server or other virtual machine network cards in the same VPC.

A blk pmd in the virtual storage module parses a data read request sent by a virtio-blk driver, and forwards a parsing result to the physical network card through the network card driver module (user network interface card driver). The physical network card encapsulates the parsing result according to the network protocol, and sends an encapsulation result to the remote storage server.

Alternatively, a net pmd in the virtual network module parses a data write request sent by a virtio-net driver, and forwards a parsing result to the physical network card through the network card driver module (user network interface card driver). The physical network card encapsulates the parsing result according to the network protocol, and sends an encapsulation result to a virtual machine memory in the same VPC.

Further, after adjusting virtual resources of the virtual storage module and the virtual network module, a first to-be-consumed virtual resource of the virtual storage module may be determined based on an adjustment result; and to-be-distributed data in a virtual machine memory is sent to the storage server by using the first to-be-consumed virtual resource.

After reading the to-be-read data, the to-be-read data may be taken as training data for training a to-be-trained speech recognition model to generate the speech recognition model.

In addition, a second to-be-consumed virtual resource of the virtual network module may further be determined based on an adjustment result;
the data read/write request of the second driver module may be received by the virtual network module, the data read/write request may be parsed by using the second to-be-consumed virtual resource to generate the corresponding parsing result, and the parsing result may be sent to the network card driver module;
to-be-distributed data in a virtual machine memory may be forwarded by the network card driver module to a physical network card of a host machine; and
the to-be-distributed data may be encapsulated by the physical network card according to a preset network transmission protocol, and an encapsulation result may be sent to at least one virtual machine in a virtual private cloud network, where the virtual private cloud network includes the target virtual machine and the at least one virtual machine.

Specifically, the first to-be-consumed virtual resource is an adjusted virtual resource of the virtual storage module, for example, an adjusted storage bandwidth; and the second to-be-consumed virtual resource is an adjusted virtual resource of the virtual network module, for example, an adjusted network bandwidth.

Performing a model training in a virtual machine is mainly to run a to-be-trained model on massive data for generating a target model, e.g. a speech recognition model, an automatic driving model, etc., through operating for a long time and debugging repeatedly. A whole training process includes two stages: 1) loading a to-be-trained model, model configuration information and libraries providing dependency from a remote storage server (such as a cloud disk) into a virtual machine memory; 2) using loaded data to train the to-be-trained model, i.e., inputting the loaded data into the to-be-trained model for processing, and using the to-be-trained model to analyze the massive data to generate a usable target model. Here, in the first process, a data volume of the to-be-trained model is generally tens of GB, hundreds of GB or so, and this data loading process occupies a large overhead of the entire training process, rendering a time consumed by the entire process of a model training relatively long.

In order to improve a data loading speed of the to-be-trained model, a cloud disk in combination of a P2P transmission manner is generally adopted at present, i.e., the training data of the model is first read from a high-performance cloud disk into some virtual machine memories, and then data read into the virtual machine memories is distributed to other virtual machine memories within a VPC network through a virtual private cloud network (VPC network) by using P2P technology. However, at present for a virtual machine, in a process of reading data from a cloud disk and in a process of writing data into virtual machine memories, a data throughput capacity of the virtual machine is limited by a storage bandwidth, and the VPC network is limited by a bandwidth of the VPC network, resulting in that the bandwidth of the VPC network is in an idle state when data is read from the cloud disk, and the storage bandwidth is in an idle state in the P2P phase. The entire loading process of the model consumes a lot of time, and network resources of the virtual machine cannot be fully utilized.

Therefore, in an embodiment of the present specification, when there is a task for training a speech recognition model in a virtual machine, first, a speech recognition model, model configuration information, and training data for performing model training may be read from a cloud disk. In this process, a flow statistics sub-module on a hardware offload card may obtain statistics on flow information of a virtual network module and a virtual storage module in real time, then analyze out a growth trend of a storage flow in combination with thresholds of a current storage bandwidth and a current network bandwidth, and send a bandwidth threshold adjusting request to a flow controlling sub-module to increase the storage bandwidth for improving the reading performance of the cloud disk, so as to read the training data into a virtual machine memory through the adjusted storage bandwidth. Next, data read into the virtual machine memory may be distributed to other virtual machines in a P2P manner through the network bandwidth of the virtual network module. In this process, the flow statistics sub-module on the hardware offload card obtains statistics on flow information of the virtual network module and the virtual storage module in real time, then performs analysis to get a growth trend of a flow in a VPC network based on thresholds of the current storage bandwidth and the current network bandwidth, and next sends a bandwidth threshold adjusting request to the flow controlling sub-module to increase the bandwidth of the VPC network, thereby improving the performance of the P2P distribution.

In addition, after adjusting the network bandwidth, a data read/write request of a virtual network card may be received by the virtual network module, the data read/write request is parsed based on an adjusted network bandwidth to generate a corresponding parsing result, and the parsing result is sent to a network card driver module; model parameters for the speech recognition model, specifically i.e., the speech recognition model, the model configuration information, and the training data for performing the model training, are forwarded to a physical network card of a host machine by the network card driver module; the model parameters are encapsulated by the physical network card according to a preset network transmission protocol, and an encapsulation result is sent to at least one virtual machine in a virtual private cloud network via a P2P manner, where the virtual private cloud network includes a target virtual machine and at least one virtual machine, that is, the target virtual machine and the at least one virtual machine are in a same VPC network.

In the embodiment of the present specification, the storage bandwidth and the network bandwidth of the virtual machine are both taken over by the hardware offload card, and a ratio of the storage bandwidth and the network bandwidth is dynamically adjusted according to a load situation of the virtual machine, thus providing a better throughput performance for an upper-layer service and significantly improving a resource utilization rate of a physical network. In addition, it is further beneficial for improving a model loading speed during the speech recognition training, thereby reducing the whole time consumed by the model training.

In an embodiment of the present specification, a data processing request received by a network card driver module within a preset time period is acquired; a first resource consumption result corresponding to a virtual storage module of a target virtual machine and a second resource consumption result corresponding to a virtual network module of the target virtual machine are determined according to a data processing type corresponding to the data processing request; and virtual resources of the virtual storage module and the virtual network module are adjusted according to the first resource consumption result and/or the second resource consumption result.

In the embodiment of the present specification, resource consumption results of the virtual storage module and the virtual network module are respectively determined according to loads of the virtual storage module and/or the virtual network module, thus a proportion of the virtual resources of the virtual storage module and the virtual network module is dynamically adjusted according to the resource consumption results. In this way, it is beneficial for improving utilization rates of virtual resources of the virtual storage module and the virtual network module, and beneficial for reducing time consumed by data processing, thus improving the efficiency of data processing.

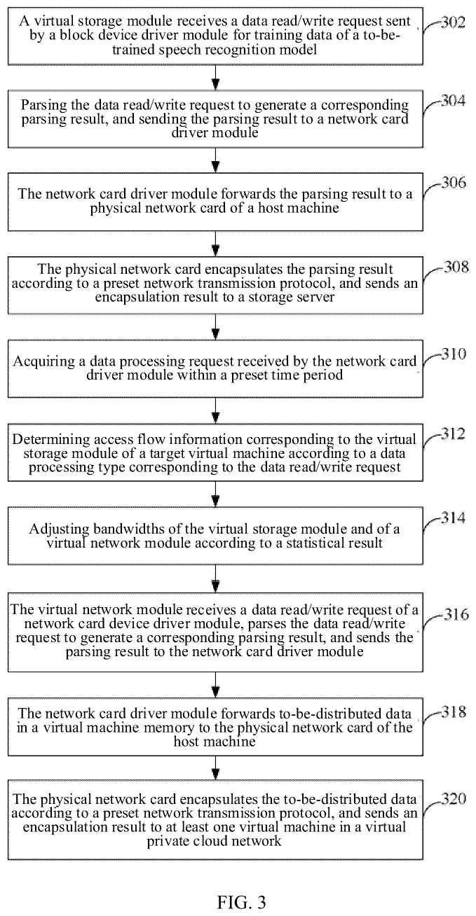

In the following, in combination with FIG. 3, an example is taken where the virtual resource processing method provided in the present specification is applied in a model training scenario, for further describing the virtual resource processing method. Here, FIG. 3 shows a flowchart of a processing process of a virtual resource processing method provided in an embodiment of the present specification, which specifically includes the following steps.

Step 302, a virtual storage module receives a data read/write request sent by a block device driver module for training data of a to-be-trained speech recognition model.

Step 304, parsing the data read/write request to generate a corresponding parsing result, and sending the parsing result to a network card driver module.

Step 306, the network card driver module forwards the parsing result to a physical network card of a host machine.

Step 308, the physical network card encapsulates the parsing result according to a preset network transmission protocol, and sends an encapsulation result to a storage server.

Specifically, the storage server parses the encapsulation result, and returns the training data according to the parsing result.

Step 310, acquiring a data processing request received by the network card driver module within a preset time period.

Step 312, determining access flow information corresponding to the virtual storage module of a target virtual machine according to a data processing type corresponding to the data read/write request.

Step 314, adjusting bandwidths of the virtual storage module and of a virtual network module according to a statistical result.

Step 316, the virtual network module receives a data read/write request of a network card device driver module, parses the data read/write request to generate a corresponding parsing result, and sends the parsing result to the network card driver module.

Step 318, the network card driver module forwards to-be-distributed data in a virtual machine memory to the physical network card of the host machine.

Step 320, the physical network card encapsulates the to-be-distributed data according to a preset network transmission protocol, and sends an encapsulation result to at least one virtual machine in a virtual private cloud network.

Here, the target virtual machine and the at least one virtual machine belong to the same virtual private cloud network.

In the embodiment of the present specification, a ratio of a storage bandwidth and a network bandwidth may be dynamically adjusted according to a load situation of a virtual machine, thus providing a better throughput performance for an upper-layer service and significantly improving a resource utilization rate of a physical network. In addition, it is further beneficial for improving a model loading speed during speech recognition training, thereby reducing the overall time consumed by the model training.

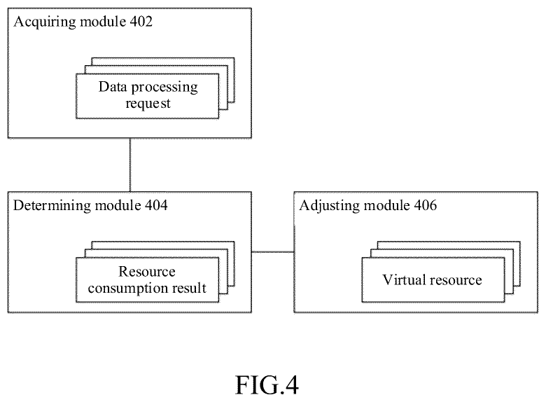

Corresponding to the foregoing method embodiments, the present specification further provides embodiments of a virtual resource processing apparatus. FIG. 4 shows a schematic structural diagram of a virtual resource processing apparatus provided in an embodiment of the present specification. As shown in FIG. 4, the apparatus includes:
an acquiring module 402, configured to acquire a data processing request received by a network card driver module within a preset time period;
a determining module 404, configured to determine, according to a data processing type corresponding to the data processing request, a first resource consumption result corresponding to a virtual storage module of a target virtual machine and a second resource consumption result corresponding to a virtual network module of the target virtual machine; and
an adjusting module 406, configured to adjust, according to the first resource consumption result and/or the second resource consumption result, virtual resources of the virtual storage module and the virtual network module.

In an implementation, the virtual resource processing apparatus further includes a first parsing module, configured to:
receive a data read/write request of a first driver module via the virtual storage module;
parse the data read/write request to generate a corresponding parsing result, and send the parsing result to the network card driver module.

In an implementation, the virtual resource processing apparatus further includes a second parsing module, configured to:
receive a data read/write request of a second driver module via the virtual network module;
parse the data read/write request to generate a corresponding parsing result, and send the parsing result to the network card driver module.

In an implementation, the virtual resource processing apparatus further includes a first encapsulating module, configured to:
forward the parsing result to a physical network card of a host machine via the network card driver module;
encapsulate the parsing result according to a preset network transmission protocol and send an encapsulation result to a storage server via the physical network card, where the encapsulation result is parsed by the storage server which returns to-be-read data of the target virtual machine according to the parsing result.

In an implementation, the virtual resource processing apparatus further includes a second encapsulating module, configured to:
forward to-be-distributed data to a physical network card of a host machine via the network card driver module;
encapsulate the to-be-distributed data according to a preset network transmission protocol, and send an encapsulation result to at least one virtual machine in a virtual private cloud network via the physical network card, where the virtual private cloud network includes the target virtual machine and the at least one virtual machine.

In an implementation, the virtual resource processing apparatus further includes an in-writing module, configured to:
determine a first to-be-consumed virtual resource of the virtual storage module based on an adjustment result;
send to-be-distributed data in a virtual machine memory to the storage server by using the first to-be-consumed virtual resource.

In an implementation, the virtual resource processing apparatus further includes a training module, configured to:
train a to-be-trained speech recognition model by taking the to-be-read data as training data, to generate the speech recognition model.

In an implementation, the virtual resource processing apparatus further includes a third encapsulating module, configured to:
determine a second to-be-consumed virtual resource of the virtual network module based on an adjustment result;
receive the data read/write request of the second driver module, parse the data read/write request by using the second to-be-consumed virtual resource to generate the corresponding parsing result, and send the parsing result to the network card driver module, via the virtual network module;
forward to-be-distributed data in a virtual machine memory to a physical network card of a host machine via the network card driver module; and
encapsulate the to-be-distributed data according to a preset network transmission protocol and send an encapsulation result to at least one virtual machine in a virtual private cloud network via the physical network card, where the virtual private cloud network includes the target virtual machine and the at least one virtual machine.

In an implementation, the determining module 404 is further configured to:
perform, according to the data processing type corresponding to the data processing request via a flow sensing sub-module in a flow adapting module, statistics on access flows in the virtual storage module and the virtual network module of the target virtual machine within the preset time period;
determine, according to a statistical result of the access flows, the first resource consumption result corresponding to the virtual storage module and the second resource consumption result of the virtual network module.

In an implementation, the adjusting module 406 is further configured to:
adjust an initial ratio of the virtual resources of the virtual storage module and the virtual network module via a flow controlling sub-module in the flow adapting module, according to the first resource consumption result and/or the second resource consumption result.

In an implementation, the adjusting module 406 is further configured to:
in a case that the first resource consumption result is greater than a first preset threshold, adjust an initial ratio of the virtual resources of the virtual storage module and the virtual network module; and/or
in a case that the second resource consumption result is greater than a second preset threshold, adjust an initial ratio of the virtual resources of the virtual storage module and the virtual network module.

The foregoing is a schematic solution of the virtual resource processing apparatus in the present specification. It should be noted that, a technical solution of the virtual resource processing apparatus and technical solutions of the virtual resource processing methods mentioned above belong to a same concept, and detail content not described in detail in the technical solution of the virtual resource processing apparatus may be found in the description of the technical solutions of the virtual resource processing methods mentioned above.

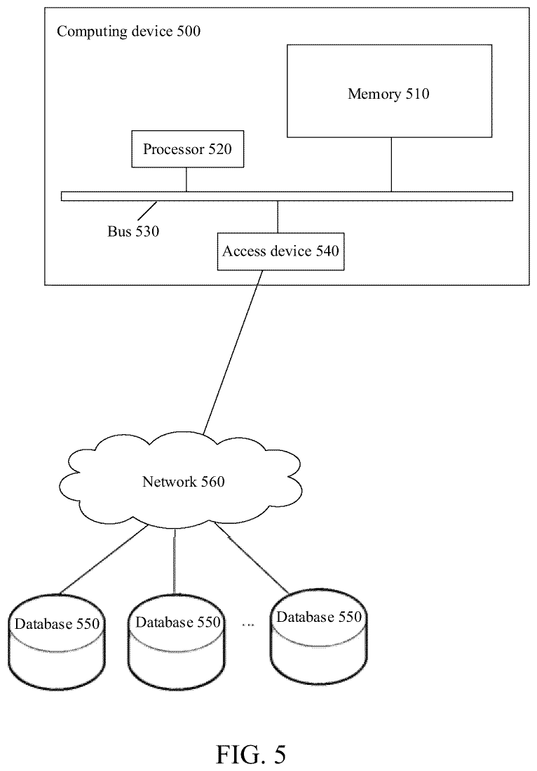

FIG. 5 shows a structural block diagram of a computing device 500 provided in an embodiment according to the present specification. Components of the computing device 500 include, but are not limited to, a memory 510 and a processor 520. The processor 520 is connected to the memory 510 via a bus 530, and a database 550 is configured to store data.

The computing device 500 also includes an access device 540, where the access device 540 enables the computing device 500 to communicate via one or more networks 560. Examples of such networks include a public switched telephone network (PSTN), a local area network (LAN), a wide area network (WAN), a personal area network (PAN), or a combination of communication networks such as the Internet. The access device 540 may include one or more of any type of wired or wireless network interfaces (e.g., a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, etc.

In an embodiment of the present specification, the above components of the computing device 500 and other components not shown in FIG. 5 may further be connected to each other, for example, via a bus. It should be understood that the structural block diagram of the computing device shown in FIG. 5 is only for illustrative purpose, rather than a limitation on the scope of the present specification. Those skilled in the art may add or replace other components as needed.

The computing device 500 may be any type of stationary or mobile computing devices, including mobile devices such as a mobile computer or a mobile computing device (e.g., a tablet, a personal digital assistant, a laptop, a notebook, a netbook, etc.), a mobile phone (e.g., a smartphone), a wearable computing device (e.g., a smart watch, smart glasses, etc.) or those of other types, or stationary computing devices such as a desktop computer or a PC (Personal Computer). The computing device 500 may further be a mobile or stationary server.

Here, the processor 520 is configured to execute such computer-executable instructions that, when the computer-executable instructions are executed by the processor, the steps of the virtual resource processing method mentioned above are implemented.

The foregoing is a schematic solution of a computing device in the present specification. It should be noted that, a technical solution of the computing device and technical solutions of the virtual resource processing methods mentioned above belong to a same concept, and detail content not described in detail in the technical solution of the computing device may be found in the description of the technical solutions of the virtual resource processing methods mentioned above.

An embodiment of the present specification further provides a computer-readable storage medium storing computer-executable instructions thereon, when the computer-executable instructions are executed by a processor, the steps of the virtual resource processing method mentioned above are implemented.

The foregoing is a schematic solution of a computer-readable storage medium in the present specification. It should be noted that, a technical solution of the storage medium and technical solutions of the virtual resource processing methods mentioned above belong to a same concept, and detail content not described in detail in the technical solution of the storage medium may be found in the description of the technical solutions of the virtual resource processing methods mentioned above.

An embodiment of the present specification further provides a computer program, when the computer program is executed in a computer, the computer is caused to perform the steps of the virtual resource processing methods mentioned above.

The foregoing is a schematic solution of a computer program in the present specification. It should be noted that, a technical solution of the computer program and technical solutions of the virtual resource processing methods mentioned above belong to a same concept, and detail content not described in detail in a technical solution of the computer program may be found in the description of the technical solutions of the virtual resource processing methods mentioned above.

The foregoing describes a specific embodiment of the present specification. Other embodiments are within the scope of the appended claims. In some cases, actions or steps recited in the claims may be executed in a different order than that in the embodiments and still can achieve a desirable result. In addition, a process depicted in a figure does not necessarily require the shown particular order or sequential order to achieve a desired result. In certain implementations, multitasking processing and parallel processing are also possible or may be advantageous.

The computer instructions include computer program codes, which may be in the form of source codes, object codes, executable files, or in some intermediate forms or the like. The computer-readable medium may include: any entity or device, recording medium, U disk, mobile hard disk, magnetic disk, optical disk, computer memory, read-only memory (ROM, Read-Only Memory), random access memory (RAM, Random Access Memory), electrical carrier signal, telecommunications signal, and software distribution medium, etc., which is capable of carrying the computer program codes. It should be noted that content contained in the computer-readable medium may be appropriately added or cut as required by legislation and patent practice within a jurisdiction. For example, in some jurisdictions, according to legislation and patent practice, a computer-readable medium does not include an electrical carrier signal and a telecommunications signal.

It should be noted that, for convenience of description, the foregoing method embodiments are expressed as a combination of a series of actions. However, those skilled in the art should know that an embodiment of the present specification is not limited by a described action order, as according to the embodiments of the present specification, some steps may be performed in other orders or at the same time. Secondly, those skilled in the art should also know that the embodiments described in the specification are all preferred embodiments, and actions and modules involved may not necessarily be necessary for the embodiments of the present specification.

In the foregoing embodiments, a description of each embodiment has its own emphasis. For a part not described in detail in a certain embodiment, reference may be made to related descriptions of other embodiments.

The above-disclosed preferred embodiments of the present specification are only used to assist in elaborating the present specification. Optional embodiments are not exhaustive in all details, nor are they intended to limit the disclosure only to a specific implementation described. Obviously, many modifications and variations are possible in light of content of the embodiments of the present specification. The present specification selects and specifically describes these embodiments in order to better explain the principles and practical applications of the embodiments in the present specification, so that those skilled in the art can understand and utilize the present specification well. The present specification is limited only by the claims and their entire scope and equivalents.

1. A virtual resource processing method, comprising:
acquiring a data processing request received by a network card driver module within a preset time period;
determining, according to a data processing type corresponding to the data processing request, a first resource consumption result corresponding to a virtual storage module of a target virtual machine and a second resource consumption result corresponding to a virtual network module of the target virtual machine;
adjusting, according to the first resource consumption result and/or the second resource consumption result, virtual resources of the virtual storage module and the virtual network module.

2. The virtual resource processing method according to claim 1, further comprising:
receiving a data read/write request of a first driver module via the virtual storage module;
parsing the data read/write request to generate a corresponding parsing result, and sending the parsing result to the network card driver module.

3. The virtual resource processing method according to claim 1, further comprising:
receiving a data read/write request of a second driver module via the virtual network module;
parsing the data read/write request to generate a corresponding parsing result, and sending the parsing result to the network card driver module.

4. The virtual resource processing method according to claim 2, further comprising:
forwarding the parsing result to a physical network card of a host machine via the network card driver module;
encapsulating the parsing result according to a preset network transmission protocol and sending an encapsulation result to a storage server via the physical network card, wherein the encapsulation result is parsed by the storage server which returns to-be-read data of the target virtual machine according to the parsing result.

5. The virtual resource processing method according to claim 3, further comprising:
forwarding to-be-distributed data to a physical network card of a host machine via the network card driver module;
encapsulating the to-be-distributed data according to a preset network transmission protocol and sending an encapsulation result to at least one virtual machine in a virtual private cloud network via the physical network card, wherein the virtual private cloud network comprises the target virtual machine and the at least one virtual machine.

6. The virtual resource processing method according to claim 4, further comprising:
determining a first to-be-consumed virtual resource of the virtual storage module based on an adjustment result;
sending to-be-distributed data in a virtual machine memory to the storage server by using the first to-be-consumed virtual resource.

7. The virtual resource processing method according to claim 4, further comprising:
training a to-be-trained speech recognition model by taking the to-be-read data as training data, to generate a trained speech recognition model.

8. The virtual resource processing method according to claim 3, wherein parsing the data read/write request to generate the corresponding parsing result, and sending the parsing result to the network card driver module comprise: parsing the data read/write request by using the second to-be-consumed virtual resource to generate the corresponding parsing result, and sending the parsing result to the network card driver module; and
the method further comprises:
determining a second to-be-consumed virtual resource of the virtual network module based on an adjustment result;
forwarding to-be-distributed data in a virtual machine memory to a physical network card of a host machine via the network card driver module;
encapsulating the to-be-distributed data according to a preset network transmission protocol and sending an encapsulation result to at least one virtual machine in a virtual private cloud network via the physical network card, wherein the virtual private cloud network comprises the target virtual machine and the at least one virtual machine.

9. The virtual resource processing method according to claim 1, wherein determining, according to the data processing type corresponding to the data processing request, the first resource consumption result corresponding to the virtual storage module of the target virtual machine and the second resource consumption result corresponding to the virtual network module of the target virtual machine comprises:
performing, according to the data processing type corresponding to the data processing request via a flow sensing sub-module in a flow adapting module, statistics on access flows in the virtual storage module and the virtual network module of the target virtual machine within the preset time period;
determining, according to a statistical result of the access flows, the first resource consumption result corresponding to the virtual storage module and the second resource consumption result of the virtual network module.

10. The virtual resource processing method according to claim 9, wherein adjusting, according to the first resource consumption result and/or the second resource consumption result, the virtual resources of the virtual storage module and the virtual network module comprises:
adjusting an initial ratio of the virtual resources of the virtual storage module and the virtual network module via a flow controlling sub-module in the flow adapting module, according to the first resource consumption result and/or the second resource consumption result.

11. The virtual resource processing method according to claim 1, wherein adjusting, according to the first resource consumption result and/or the second resource consumption result, the virtual resources of the virtual storage module and the virtual network module comprises:
in a case that the first resource consumption result is greater than a first preset threshold, adjusting an initial ratio of the virtual resources of the virtual storage module and the virtual network module; and/or
in a case that the second resource consumption result is greater than a second preset threshold, adjusting an initial ratio of the virtual resources of the virtual storage module and the virtual network module.

12. A computing device, comprising:
a memory and a processor;
wherein the memory is configured to store computer-executable instructions, the processor is configured to execute the computer-executable instructions, and when the computer-executable instructions are executed by the processor, the processor is caused to:
acquire a data processing request received by a network card driver module within a preset time period;
determine, according to a data processing type corresponding to the data processing request, a first resource consumption result corresponding to a virtual storage module of a target virtual machine and a second resource consumption result corresponding to a virtual network module of the target virtual machine;
adjust, according to the first resource consumption result and/or the second resource consumption result, virtual resources of the virtual storage module and the virtual network module.

13. (canceled)

14. A non-transitory computer-readable storage medium storing computer-executable instructions thereon, when the computer-executable instructions are executed by a processor, the following operations are implemented:
acquiring a data processing request received by a network card driver module within a preset time period;
determining, according to a data processing type corresponding to the data processing request, a first resource consumption result corresponding to a virtual storage module of a target virtual machine and a second resource consumption result corresponding to a virtual network module of the target virtual machine;
adjusting, according to the first resource consumption result and/or the second resource consumption result, virtual resources of the virtual storage module and the virtual network module.

15. The computing device according to claim 12, wherein the processor is further caused to:
receive a data read/write request of a first driver module via the virtual storage module;
parse the data read/write request to generate a corresponding parsing result, and send the parsing result to the network card driver module.

16. The computing device according to claim 12, wherein the processor is further caused to:
receive a data read/write request of a second driver module via the virtual network module;
parse the data read/write request to generate a corresponding parsing result, and send the parsing result to the network card driver module.

17. The computing device according to claim 15, wherein the processor is further caused to:
forward the parsing result to a physical network card of a host machine via the network card driver module;
encapsulate the parsing result according to a preset network transmission protocol and send an encapsulation result to a storage server via the physical network card, wherein the encapsulation result is parsed by the storage server which returns to-be-read data of the target virtual machine according to the parsing result.

18. The computing device according to claim 16, wherein the processor is further caused to:
forward to-be-distributed data to a physical network card of a host machine via the network card driver module;
encapsulate the to-be-distributed data according to a preset network transmission protocol and send an encapsulation result to at least one virtual machine in a virtual private cloud network via the physical network card, wherein the virtual private cloud network comprises the target virtual machine and the at least one virtual machine.

19. The computing device according to claim 17, wherein the processor is further caused to:
determine a first to-be-consumed virtual resource of the virtual storage module based on an adjustment result;
send to-be-distributed data in a virtual machine memory to the storage server by using the first to-be-consumed virtual resource.

20. The computing device according to claim 17, wherein the processor is further caused to:
train a to-be-trained speech recognition model by taking the to-be-read data as training data, to generate a trained speech recognition model.

21. The computing device according to claim 16, wherein the processor is specifically caused to:
parse the data read/write request by using the second to-be-consumed virtual resource to generate the corresponding parsing result, and send the parsing result to the network card driver module; and
the processor is further caused to:
determine a second to-be-consumed virtual resource of the virtual network module based on an adjustment result;
forward to-be-distributed data in a virtual machine memory to a physical network card of a host machine via the network card driver module;
encapsulate the to-be-distributed data according to a preset network transmission protocol and send an encapsulation result to at least one virtual machine in a virtual private cloud network via the physical network card, wherein the virtual private cloud network comprises the target virtual machine and the at least one virtual machine.
